(19) United States
(12) Patent Application Publication
(10) Pub. No.: US 2001/0038493 A1
(43) Pub. Date: Nov. 8, 2001

(54) Protective panel for display window of electronic device

(76) Inventors: Nobuhisa Watanabe, Tokyo (JP); Mikihiro Kuramitsu, Funabashi-shi (JP)

Correspondence Address: BIRCH STEWART KOLASCH & BIRCH, PO BOX 747, FALLS CHURCH, VA, 22040-0747, US

(21) Appl. No.: 09/850,079

(22) Filed: May 8, 2001

(30) Foreign Application Priority Data
May 8, 2000 (JP) 2000-134506

(51) Int. Cl. G02B 1/00; G02B 27/00

(52) U.S. Cl. 359/609; 359/507; 359/601

(57) ABSTRACT

It is an object of this invention to provide a protective panel having a liquid crystal display window with a transparent central portion and a semi-transparent peripheral portion, wherein the protective panel could be manufactured in a simple process and could prevent an inside of an electronic device from being seen from outside through the peripheral portion.

An exemplary structure of the protective panel for a display window of an electronic device regarding this invention is a protective panel P comprising a semi-transparent front surface printing layer 11 having a colorless and transparent window portion formed at a central portion 11b; and a non-transparent back surface printing layer 18 having a colorless and transparent window portion formed at a central portion 18b.

### BACKGROUND OF THE INVENTION

1. Field of the Invention

This invention relates to a protective panel attached to a liquid crystal display portion of a cellular phone or the like, and more particularly, to a panel with an exquisite decoration at a rim portion of the panel.

2. Description of Related Art

Typically, a transparent protective panel is attached to a liquid crystal display window of an electronic device such as a cellular phone for protection means. Conventionally, a panel of a colorless, transparent resin formed of a scratch-resistant cured layer has been used on a surface for the protective panel; however, the protective panel nowadays is being decorated with a small area decoration or print since cellular phones have been brought in as a fashion.

An electronic device of a see thru type using a semi-transparent resin is a recent trend and a need to apply a see thru type design to a peripheral portion of the protective panel without affecting a display is growing.

As methods of molding a protective panel with a colorless, transparent center having a semi-transparent periphery, there are: a method of separately molding a central portion panel and a peripheral portion panel and then engaging the respective panels; or an insert-molding method in which a united body is formed by arranging a transparent central portion panel into a mold and injecting a semi-transparent resin to the periphery.

However, the foregoing molding methods raised problems of complicating a manufacturing process and increasing production costs.

Further, forming the peripheral portion of the protective panel into a see thru type while obtaining a sufficient display area for the liquid crystal display portion of the central portion would render inferior the appearance of the display portion due to the fact that the peripheral portion of the protective panel would overlap with the outer portion of the liquid crystal display portion and cause wires or the like surrounding the liquid crystal portion to become visible through the semi-transparent peripheral portion.

Therefore, it is an object of this invention to provide a protective panel having a liquid crystal display window with a transparent central portion and a semi-transparent peripheral portion, wherein the protective panel could be manufactured in a simple process and could prevent an inside of an electronic device from being seen from outside through the peripheral portion.

### SUMMARY OF THE INVENTION

This invention is aimed to solve the foregoing problems by providing a protective panel for a display window of an electronic device having an exemplary structure in which a semi-transparent decoration is applied to a peripheral portion except for a front surface of a liquid crystal display window portion and a decoration on a back surface could be seen while the back surface is applied with a non-transparent decoration.

### BRIEF DESCRIPTION OF THE DRAWINGS

The above and other objects and features of the invention are apparent to those skilled in the art from the following preferred embodiments thereof when considered in conjunction with the accompanied drawings, in which:

FIG. 1 is a perspective view showing a protective panel of an embodiment;

FIG. 2 is an explanatory view showing a process where a primary continuous film and a secondary continuous film successively passes though between a fixed metal mold and a movable metal mold;

FIG. 3 is a side cross-sectional view showing a primary consecutive film and a secondary consecutive film;

FIG. 4 is an explanatory view showing a manufacturing method of a protective panel; and

FIG. 5 is an explanatory view showing a process of forming an anti-reflection layer with a sputtering method.

### DESCRIPTION OF THE PREFERRED EMBODIMENTS

The protective panel for a display window of an electronic device regarding this invention will be explained hereinafter with reference to the drawings.

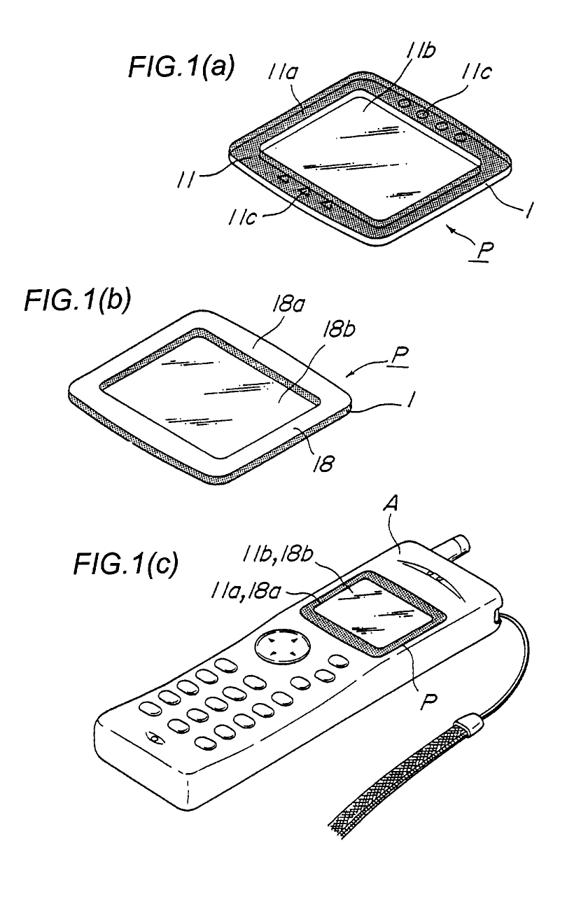

FIG. 1 is a view showing an example of a protective panel manufactured in accordance with this embodiment. A protective panel P is a panel engaged to a display window of an electronic device such as a cellular phone for means to protect a display window portion. FIG. 1(a) shows a front surface of the protective panel P, and FIG. 1(b) shows a back surface of the protective panel P in which the protective panel P is a transparent acrylic plate member 1 having a front surface printing layer 11 formed on the front surface of the plate member 1 and a back surface printing layer 18 formed on the back surface of the plate member 1.

While a rim portion 11a of the front surface printing layer 11 is colored and semi-transparent, a central portion 11b is colorless and transparent. In the same manner, while only a rim portion 18a of the back surface printing layer 18 is printed for reflection such as silver, a central portion 18b is colorless and transparent. Although, both central portions 11b and 18b could be made colorless and transparent by not forming a printing layer, the same effect could be achieved by applying transparent ink.

Thus structured, the rim portion 11a of the protective panel P would be colored and semi-transparent when seen from the front surface side and the protective panel P would seem as though the protective panel P is structured from a combination of a colored transparent resin and a colored semi-transparent resin since the reflection printed rim portion 18a of the back surface would be seen through the rim portion 11a.

Even though a front surface rim portion is of a see thru type, an internal board of a cellular phone A could not be seen through the front surface rim portion since the back surface printing layer of the protective panel P is not transparent.

As shown in FIG. 1(c), the protective panel P could be used by attachment to a liquid crystal display window of the cellular phone A.

A manufacturing method of the protective panel P for the display window of the electronic device regarding this embodiment shall hereinafter be described.

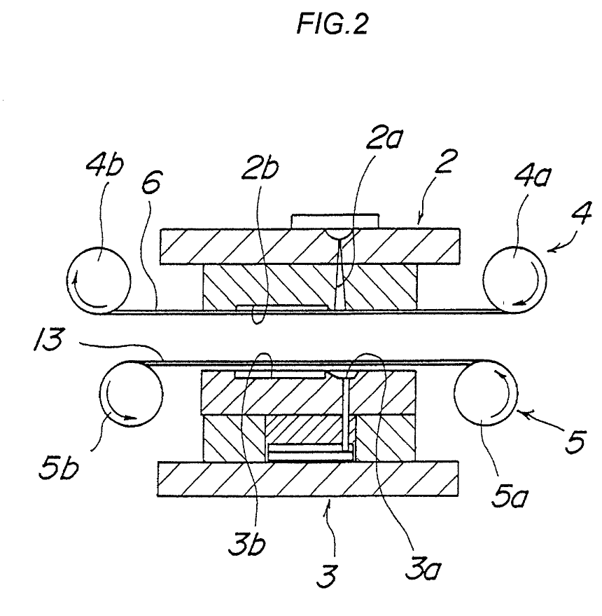

FIG. 2 shows a first process in which a primary continuous film 6 and a secondary continuous film 13 are passed though between a fixed metal mold 2 and a movable metal mold 3.

The fixed metal mold 2 is formed with a gate 2a for injecting a transparent acrylic resin and a cavity 2b for engaging to the gate 2a. The movable metal mold 3 also is formed with a gate 3 a for injecting a transparent acrylic resin and a cavity 2b engaging to the gate 3a.

The gate 2a is arranged to a position facing the gate 3a when the fixing metal mold 2 and the movable metal mold 3 are clamped.

A primary winding device 4 and a secondary winding device 5 are attached to the fixed metal mold 2 and the movable metal mold 3, respectively. Each of the winding devices 4 and 5 respectively has a feeding roll 4a and feeding roll Sa and a winding roll 4b and a winding roll 5b in which continuous films 6 and 13 are rolled between the devices.

Preparation is completed when the primary continuous film 6 and the secondary continuous film 13 are wrapped and secured to the feeding rolls 4a and 5a, and when a tip portion of the continuous films are passed through between the fixed metal mold 2 and the movable metal mold 3, and when the continuous films are wrapped to the winding rolls 4b and 5b.

First, the winding devices 4 and 5 are activated and the primary continuous film 6 and the secondary continuous film 13 are intermittently fed. The intermittent feeding procedure is controlled so that the printing pattern on the continuous films 6 and 13 would always match respectively to the cavity 2b and cavity 3b of the fixed metal mold 2 and the movable metal mold 3.

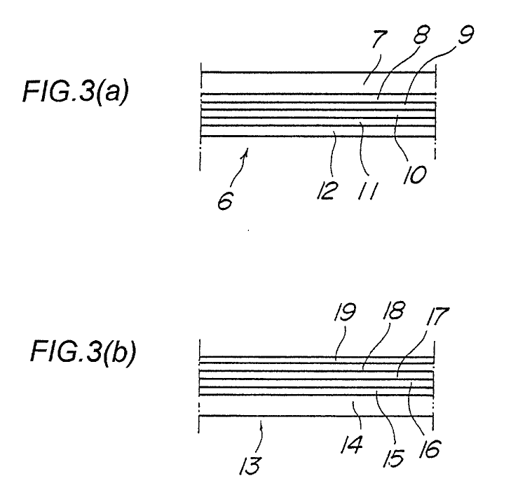

As shown in FIG. 3(a), the primary continuous film 6 is formed in a stacking manner of a polyethylene terephthalate made base film 7; a peeling layer 8 made from a non-adhesive material; a UV cured layer 9 serving to enhance surface solidity; an anchor layer 10 serving to enhance print fixation; a print layer 11, and an adhesive layer 12. In a same manner, FIG. 3(b) shows the secondary continuous film 13 formed in a stacking manner of a base film 14, a peeling layer 15, a UV cured layer 16, an anchor layer 17, a print layer 18 and an adhesive layer 19.

The UV cured layers 9 and 16 respectively serve as a front surface anti-reflection undercoating layer and a back surface anti-reflection undercoating layer wherein an anti-reflection processing (described afterwards) is applied onto the layers so as to form the anti-reflection layer. Accordingly, by using the UV cured layer 9, the anti-reflection layer could steadily be formed whereas the anti-reflection layer is difficult to be formed on an acrylic resin.

A printed portion and a portion not subject to printing are formed at the print layers 11, 18 in which a transparent display window (see FIG. 1) is formed by having a transparent acrylic resin layer at the back surface and the front surface of the central portions 11b, 18b of the portion not subject to printing. The print layers 11, 18 form a plurality of independent print patterns at a prescribed space onto the continuous films 6, 13.

Although the anti-reflection undercoating layer above is comprised of UV cured layer 9 and 16, as long as a portion forming the display windows 11b and 18 is transparent, other printing layers could be used.

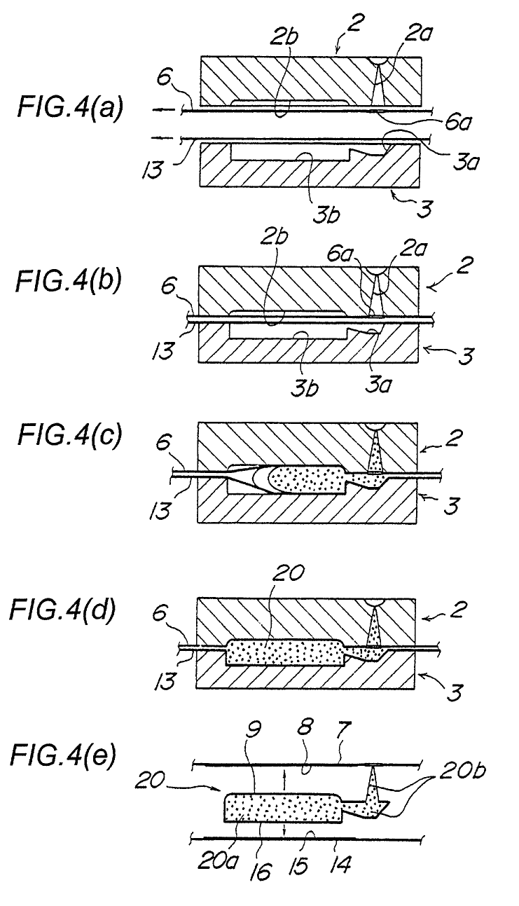

As shown in FIG. 4(a), in a state where the respective adhesive layers 12 and 19 face each other, the primary continuous film 6 arranged on the same side as the fixed metal mold and the secondary continuous film 13 arranged on the same side as the movable metal mold are fed between the fixed metal mold and the movable metal mold so that feeding direction of the primary continuous film 6 and the feeding direction of the secondary continuous film 13 would become parallel.

As shown in FIG. 4(b), after the primary continuous film 6 and the secondary continuous film 13 are fed between the fixed metal mold 2 and the movable metal mold 3, the fixed metal mold 2 and the movable metal mold 3 are clamped.

As shown in FIGS. 4(c), (d), the primary continuous film 6 has a hole 6a formed at a prescribed space in which each gate 2a, 3a injects a transparent acrylic resin between the primary continuous film 6 and the secondary continuous film 13 via the hole 6a. The injected transparent acrylic resin fills the cavities 2b and 3b by pressing the primary continuous film 6 and the secondary continuous film 13 against the fixed metal mold and the movable metal mold so that the primary continuous film 6 and secondary continuous film 13 would become a united body to form a molded article 20.

As shown in FIG. 4(e), the base films 6 and 13 are peeled off from the molded article 20 after the molded article is solidified. The primary continuous film 6 and the secondary continuous film 13 are both separated from the molded article 20 in which the primary continuous film 6 and the secondary continuous film 13 are separated between the peeling layers 8, 15 and the UV cured layers 9, 16.

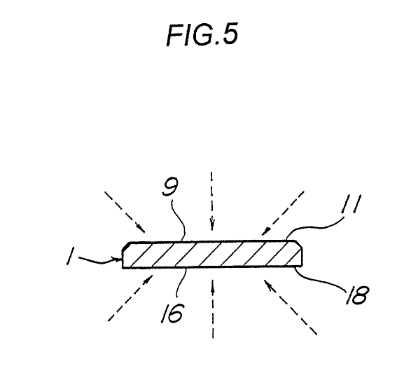

Then, a sprue 20b, which is a remaining molding portion of the gate, is cut and removed to form a final product 20a; then, as shown in FIG. 5, the anti-reflection layer is formed onto the UV cured layers 9,16 serving as anti-reflection undercoating layers by means of sputtering so that the protective panel P shown in FIG. 1 could be molded. The anti-reflection layer serves to prevent reflection and enhance visibility.

Accordingly, with this embodiment, printing patterns of the continuous film could be successively fed, and successive manufacturing of the protective panel P could be performed by repeating the foregoing process.

Although, a transfer in-molding process is used for molding the protective panel regarding this invention, the protective panel could also be molded by insert molding in which a printed sheet is inserted into a metal mold. In such case, an anti-reflection layer could be formed on a sheet surface beforehand, and a following anti-reflection layer forming process could be omitted.

Although, the back surface described above is decorated by a printing means, a back surface decorated layer could be formed by means of vapor deposition.

Although, this embodiment is described by using a protective panel for a display window of a cellular phone, the protective panel could also be attached to a liquid crystal display portion for a controller of a household electrical appliance or the like.

As explained above, by applying the semi-transparent print to the rim portion of the window of the front surface printing layer and by applying the non-transparent print to the rim portion of the back surface printing layer, a protective panel for a display window of an electronic device having an exquisite appearance could be provided in which the protective panel would seem as though the protective panel is structured from a combination of a colorless transparent resin and a colored transparent resin.

By forming the anti-reflection layer at least on the front surface printing layer, the visibility of the display window could be enhanced since the reflection of external light could be restrained and interfering reflections could be prevented.

By molding with a transfer in-molding process, the protective panel having the aforementioned structure could be efficiently manufactured.

The foregoing description of a preferred embodiment of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

What is claimed is:

1. A protective panel for a display window of an electronic device comprising:
a semi-transparent front surface decorative layer having a colorless and transparent window portion formed at a center of the semi-transparent front surface decorative layer; and
a non-transparent back surface decorative layer having a colorless and transparent window portion formed at a center of the non-transparent back surface decorative layer.

2. The protective panel according to claim 1, wherein an anti-reflection layer is formed at least on top of the front surface layer.

3. The protective panel according to claim 1 or claim 2, wherein the decorative layer is molded from a transfer in-molding process by using a continuous film having at least a peeling layer and a printing layer on a base film.
